(19) United States
(12) Patent Application Publication
(10) Pub. No.: US 2014/0301094 A1
(43) Pub. Date: Oct. 9, 2014

(54) METHOD, CONTROL UNIT, AND COMPUTER PROGRAM PRODUCT FOR SETTING A RANGE OF A HEADLIGHT OF A VEHICLE

(71) Applicants: Tobias Ehlgen, Ravensburg (DE); Johannes Foltin, Ditzingen (DE); Thomas Friedrich, Reisbach/Griesbach (DE)

(72) Inventors: Tobias Ehlgen, Ravensburg (DE); Johannes Foltin, Ditzingen (DE); Thomas Friedrich, Reisbach/Griesbach (DE)

(21) Appl. No.: 14/240,210

(22) PCT Filed: Jun. 25, 2012
(86) PCT No.: PCT/EP2012/062208

§ 371 Date: May 13, 2014

(30) Foreign Application Priority Data
Aug. 23, 2011 (DE) 10 2011 081 395.0

(51) Int. Cl. B60Q 1/10

(52) U.S. Cl. CPC B60Q 1/10
USPC 362/466

(57) ABSTRACT

A method for setting a headlight range of a headlight of a vehicle. The method includes a step of provision a signal which represents a pitch angle of the vehicle and a step of changing the headlight range of the headlight in response to the provided signal.

### FIELD

The present invention relates to a method for setting a headlight range of a headlight of a vehicle, a corresponding control unit, and a corresponding computer program product.

### BACKGROUND INFORMATION

The visibility range at night is related to the brightness of the headlights. Therefore, ever-brighter headlight systems are being developed which are reaching the legal limits. This has been made possible by the introduction of new light sources in the headlight. Headlights having high-pressure gas discharge lamps (“xenon headlights”) are, for example, significantly brighter than headlights having halogen incandescent lamps (“halogen headlights”). If headlights exceed a certain level of brightness, they must be equipped with an automatic headlight range adjustment and a headlight washer system. This significantly increases the cost of the lighting system to be manufactured, resulting in fewer headlights having “good” light being installed in vehicles in the middle and lower classes. The light quality/intensity has a direct impact on the visibility range and thus the risk of accidents. Economical approaches are therefore important for all vehicles.

German Patent Application No. DE 102 54 806 B4 describes a method for processing information from at least two information sources in a motor vehicle.

### SUMMARY

The present invention provides an example method for setting a headlight range of a headlight of a vehicle, the method includes the following steps:
providing a signal which represents a pitch angle of the vehicle; and
changing the headlight range of the headlight in response to the provided signal.

Furthermore, the present invention provides an example control unit for setting a headlight range of a headlight of a vehicle, the control unit having the following features:
an interface for reading in a signal which represents a pitch angle of the vehicle; and
a unit for changing the headlight range of the headlight in response to the read-in signal.

The present invention thus provides an example control unit which is designed to carry out or implement the steps of the example method according to the present invention in corresponding devices. This embodiment variant of the present invention in the form of a control unit may also be used to achieve the object of the present invention rapidly and efficiently.

A control unit may presently be understood to be an electric device which processes sensor signals and outputs control signals as a function of the sensor signals. The control unit may have an interface which may have a hardware- and/or software-based design. In a hardware-based design, the interfaces may, for example, be part of a so-called system ASIC which contains a wide variety of functions of the control unit.

However, it is also possible that the interfaces are self-contained integrated circuits or are made up at least partially of discrete components. In a software-based design, the interfaces may be software modules which, for example, are present on a microcontroller in addition to other software modules.

Another advantage relates to a computer program product including program code which may be stored on a machine-readable medium such as a semiconductor memory, a hard-disk drive, or an optical memory, and which is used for carrying out the method according to one of the specific embodiments described above, if the program is executed on a computer or a device.

A pitch angle may be understood to be an angle at which the front section of the vehicle is inclined further toward the road surface than the rear section. The signal may be obtained in various ways. For example, it is possible that the signal is provided using information which represents a mass of the vehicle. The signal may also be obtained using an evaluation of data which originate from a camera which is already installed as standard equipment in a plurality of vehicles. A headlight range is to be understood as an expanse or boundary line ahead of the vehicle which delimits an area which is illuminated by the at least one headlight having a predefined brightness. Changing the headlight range of the headlight may be understood as a reduction of the headlight range through a decrease in the size of the illuminated area ahead of the vehicle or an increase in the size of the area illuminated by the at least one headlight. By decreasing or increasing the size, it is possible to avoid blinding a road user due to an incorrect or undesirable setting or a headlight range of the headlights which is too large.

The present invention is based on the realization that an automatic adjustment of the headlight range may be implemented in a very simple manner through the adjustment of the illumination of the area ahead of the vehicle based on the signal which represents the pitch angle of the vehicle. In particular, it is possible to utilize the fact that a static change of the pitch angle which is, for example, caused by a downward spring deflection of the vehicle in the rear section, may be detected using a sensor which is technically simple and which is often already installed in a vehicle as standard. In this way, it is possible to make additional use of a signal which is often already provided in order to implement an additional safety functionality in the vehicle.

It is also advantageous if, according to one specific embodiment of the present invention, in the step of provision, the signal is provided using an image signal of a camera or an image signal of a sensor which detects surroundings of the vehicle at least two-dimensionally, in particular a forward-looking sensor or a backward-looking sensor. An image signal may be understood to be measurement data which represent surroundings of the vehicle which are detected at least two-dimensionally. Such a specific embodiment of the present invention provides the advantage of an additional use of a signal provided by the camera or the sensor. In this way, it is possible to avoid having to provide additional sensors for ascertaining the pitch angle of the vehicle, which would increase the manufacturing costs of such a system.

In order to achieve an evaluation of the information from an image of the camera or the optical sensor which is technically simple to implement, according to another specific embodiment of the present invention, in the step of provision, it is possible to provide the signal using a result of an evaluation of the image signal from the camera or the image signal from the sensor detecting the surroundings, a region of origin of the image signal from which objects seem to emerge being compared in a comparison with an expected region of origin from which objects at a known pitch angle of the vehicle should emerge in order to provide the signal based on a result of the comparison, and/or a subsidence region of the image signal in which objects seem to disappear being compared in another comparison with an expected subsidence region in which objects should disappear at a known pitch angle of the vehicle in order to provide the signal based on the result of the other comparison. A region of origin may be understood to be a subregion of the camera image from which objects in the image seem to emerge. This may, for example, be achieved using an evaluation of motion trajectories of objects, the motion trajectories converging to a specific subregion of the image of the camera, namely the region of origin, or pointing to this area. It is thus possible to utilize the fact that the motion trajectories at different pitch angles, i.e., different angles at which the camera or the optical sensor looks at the surroundings ahead of the vehicle, also point to different subregions of the image. By comparing that subregion of the image from which the instantaneous motion trajectories are identified or ascertained with a subregion in a fixed predefined viewing direction of the camera (i.e., a fixed predefined pitch angle of the vehicle, since the camera is securely connected to the vehicle), the instantaneous pitch angle of the vehicle may also be determined. In addition to a forward-looking sensor (for example, front camera, radar sensor, ultrasound, . . . ), the sensor detecting the surroundings of the vehicle may also be, for example, a backward-aimed sensor. With a backward-aimed sensor, no objects emerge from the field of expansion, but seem to disappear within it (because of the reversed direction of travel).

According to another specific embodiment of the present invention, in the step of provision, an identification of a topographical profile of a road surface ahead of the vehicle may be carried out, the provision of the signal taking into account the topographical profile. A topographical profile of the road surface ahead of the vehicle may be understood to be an identification of the profile of the road surface over bumps or in troughs. Such a specific embodiment of the present invention provides the advantage of a forward-looking control of the headlight range, making it possible, for example, to increase the headlight range if a slope has been identified ahead of the vehicle from the topographical profile of the road surface.

Furthermore, it is advantageous if, according to another specific embodiment of the present invention, in the step of provision, the signal is provided based on an estimated or measured mass of the vehicle or a mass of a payload of the vehicle. Such a specific embodiment of the present invention provides the advantage of a multiple use of signals of sensors which are often already installed in the vehicle for determining the mass of the vehicle or a payload of the vehicle.

The signal may be ascertained in a way which is technically particularly simple if, in the step of provision, the signal is provided using a sensor signal of a range sensor on one axle of the vehicle. A range sensor may be understood to be a sensor which detects motion over a distance. The use of a range sensor provides a robust and largely error-free determination of the pitch angle.

According to another specific embodiment of the present invention, in the step of provision, the signal may be provided based on the range sensor which is situated on a rear axle of the vehicle. Such a specific embodiment of the present invention provides the advantage that the motion of the vehicle on the rear axle during downward spring deflection or upward spring deflection is very great, since, on the one hand, the payload is usually stowed in the rear section of the vehicle, and on the other hand, during a pitching motion of the vehicle about the front axle, the change of the distance is greatest on the rear axle, so that when using a signal of the range sensor situated on the rear axle, it is possible to achieve highly accurate results.

It is also advantageous if, according to a particular specific embodiment of the present invention, in the step of provision, the signal is provided using information of an engine control unit and/or driving data of the vehicle. An engine control unit may be understood to be a unit which, in response to control signals input by a driver of the vehicle, outputs corresponding engine control signals in order to, for example, adjust a power, rotational speed, torque, or similar engine parameters to the values desired by the driver. Such a specific embodiment of the present invention provides the advantage of allowing an additional use of values which are usually already available in the vehicle, in order to increase the driving safety of the vehicle in this way by making multiple use of signals which are already available.

Furthermore, according to another specific embodiment of the present invention, in the step of provision, the signal may be determined using information about a rotational speed of an engine of the vehicle, a rotational speed of at least one wheel of the vehicle, the wheel slip of at least one wheel, an acceleration, in particular of the vehicle, and/or a drive torque of the engine of the vehicle. An evaluation of the wheel slip makes use of the fact that the greater the weight which a wheel carries, the greater its friction and the lower its wheel slip. This weight ratio may be used to calculate the load distribution. Such a specific embodiment of the present invention provides the advantage of using signals of sensors which are often already installed in the vehicle and the evaluation which these sensors provide, which are relevant to other vehicle safety functions. In this way, it is therefore possible to obtain an additional benefit in a very economical manner by using the signals of existing sensors.

### BRIEF DESCRIPTION OF THE DRAWINGS

The present invention is explained in greater detail below by way of example with the aid of the figures.

FIGS. 1A through C show schematic representations of a vehicle in which the headlight range is altered due to various factors.

FIG. 2 shows a block diagram of a vehicle in which an exemplary embodiment of the present invention is used.

FIG. 3 shows a schematic representation of an evaluation of an image of the camera of a region of origin from which objects seem to emerge.

FIG. 4 shows a flow chart of an exemplary embodiment of the present invention.

### DETAILED DESCRIPTION OF EXAMPLE EMBODIMENTS

In the following description of preferred exemplary embodiments of the present invention, identical or similar reference numerals are used for the elements which are depicted in the various figures and act similarly, a repeated description of these elements being omitted.

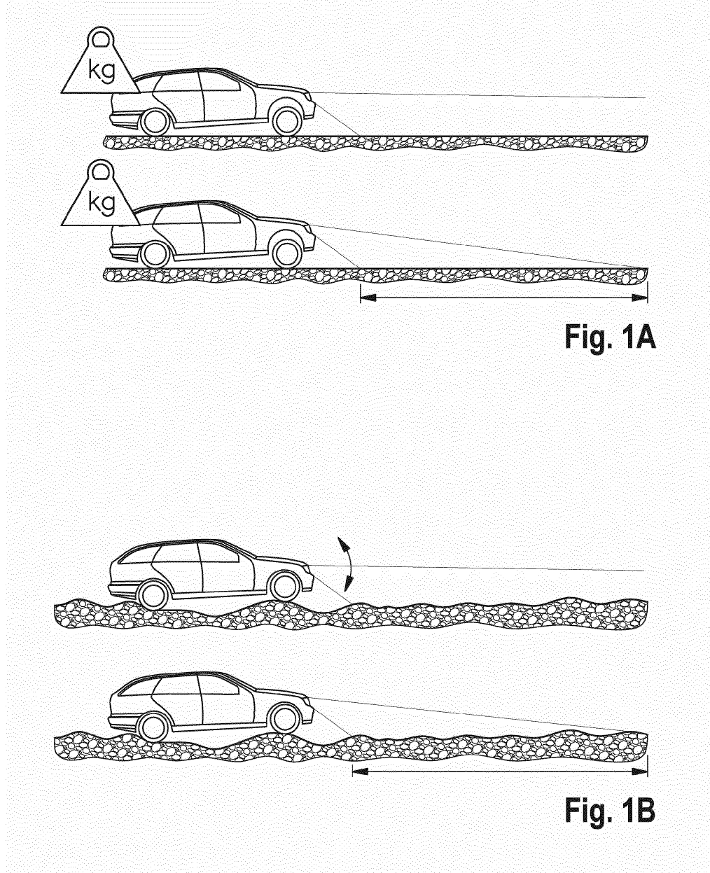

A system for headlight range adjustment may be implemented in various embodiment variants. There is a simple load compensation which sets the headlights in such a way that the range remains constant under load. Such a static headlight range adjustment is depicted in the illustrations in FIG. 1A, the upper illustration in FIG. 1A showing how an increase in weight in the rear section of the vehicle causes an increase of the headlight range, so that a corresponding lowering of a light cone emitted by the headlights of the vehicle must be carried out in order not to blind other road users (see lower illustration in FIG. 1A). In a dynamic headlight range adjustment as depicted in the two partial figures in FIG. 1B, an attempt is made to set the headlights to a constant headlight range as a function of the instantaneous pitching motion of the vehicle (for example, when driving over an uneven surface). If a beam angle is selected which is too high, as shown in the upper illustration in FIG. 1B, other road users may be blinded; therefore, a beam angle should preferably be selected for light emitted from the headlights, as shown in the lower illustration in FIG. 1B. In an enhanced headlight range adjustment as illustrated in the two partial figures in FIG. 1C, the headlights of the vehicle are set in such a way that they carry out a topography compensation (also forward-looking, depending on the system design), for example, raising the light cone before a crest. In this case, it might, for example, be detected that the road surface (ahead) has a slope, so that in order to achieve a desired headlight range, the beam angle of the light emitted by the headlight should be set flatter, in order to be able to illuminate the road surface area ahead of the vehicle far enough even if the road surface is rising.

For static headlight range adjustment (in this case meaning load compensation), a level sensor may, for example, be provided on one axle which provides a signal to be correspondingly evaluated. For dynamic/enhanced headlight range adjustment, at least two sensors are necessary. A camera system as used for high-beam assistants, lane keeping assistants, and traffic sign recognition may be used for the forward-looking detection of the vertical profile of the road surface. It is thus possible to implement an enhanced headlight range adjustment in a technically very simple manner. Alternatively or additionally, an evaluation of data of the engine management and/or driving data may also be used for determining the pitch angle, thus eliminating the need for a level sensor system for the load compensation.

An automatic headlight range adjustment is mandatory for vehicles having xenon lighting. This is intended to compensate for the pitch of the vehicle. The longitudinal acceleration of the vehicle and range sensors on the front and rear axles are used for calculating the positioning angle of the headlight range adjustment.

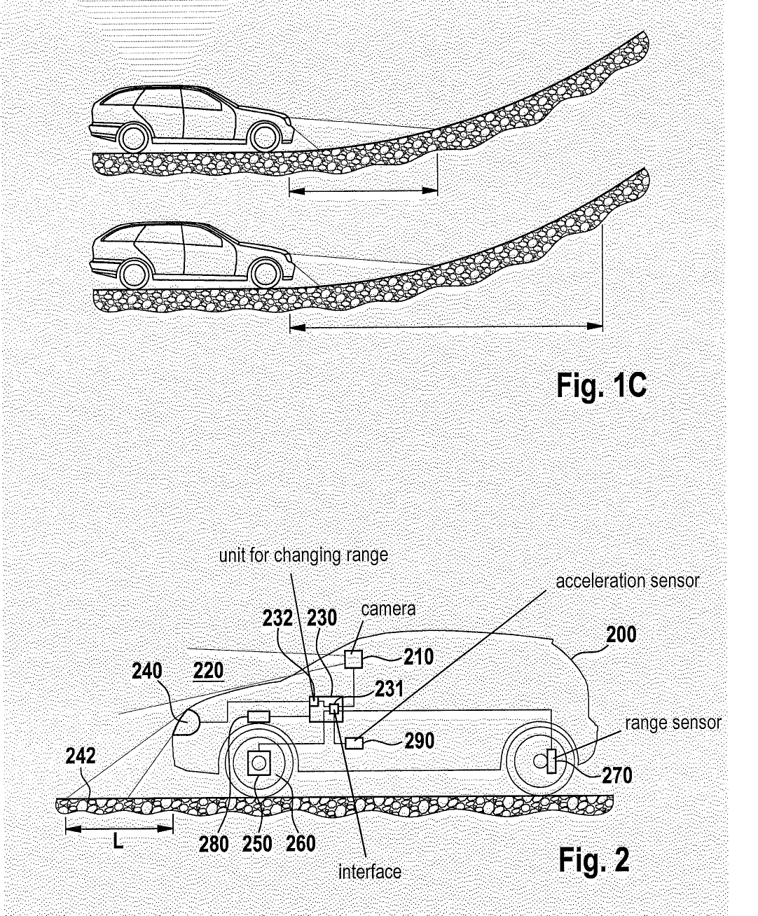

FIG. 2 shows a block diagram of a vehicle 200 in which an exemplary embodiment of the present invention is used. Vehicle 200 has a camera 210 or more generally a forward-looking sensor, preferably, an optical sensor or a radar sensor, which detects objects or a setting in a detection area 220 around vehicle 200 and transmits to a control unit 230 which is designed to control the light emission by vehicle headlights 240. Control unit 230 includes an interface 231 for reading in a signal which represents a pitch angle of vehicle 200 and a unit for changing a headlight range L of headlight 240 in response to the read-in signal. Headlights 240 are designed to illuminate an illumination area 242 ahead of the vehicle with a predefined or modifiable light intensity, up to a headlight range L which is to be set. Furthermore, vehicle 200 has a rotational-speed sensor 250 connected to control unit 230 for detecting a rotational speed of a wheel 260, for example, of a front axle of vehicle 200, a range sensor 270 connected to control unit 230 for measuring a downward spring deflection under a load of the rear axle, an interface connected to control unit 230 for reading in a torque provided by engine 280 of the vehicle, and an acceleration sensor 290 which is designed to measure an acceleration and to transmit information representing the acceleration to control unit 230.

A dynamic headlight range adjustment may be implemented with the aid of a pitch rate sensor. The pitch rate or pitch angle may also be estimated from the image(s) which was/were recorded by camera 210 of the vehicle.

The approach provided here is also intended to simplify the determination of the pitch angle caused by a payload. The static headlight range adjustment, which compensates for the (static) pitch angle which is caused by the load, may be ascertained by evaluating the FOE (focus of expansion) in the image of camera 210. The FOE forms a subregion 310 of image 300 of camera 210, as shown in FIG. 3. Trajectories 320 of objects detected in image 300 seem to originate from the region of origin 310. This region of origin may therefore be interpreted as the “vanishing point” in image 300. Image 300 “grows” out of it; i.e., all objects also emerge from there, since this is the driving direction. A specific pitch angle of vehicle 200 is also associated with this region of origin 310. If vehicle 200 is then loaded, it will usually deflect downward in the rear vehicle section, causing the pitch angle to change. For example, the “viewing direction” of camera 210 in the vehicle turns somewhat upward, so that region of origin 330 of the objects is then shifted somewhat downward with respect to the first region of origin in image 300 when vehicle 200 is deflected downward. If the FOE (i.e., region of origin 330) is constantly above or below the FOE (i.e., region of origin 310) ascertained by the calibration, camera 210 is aimed in a direction other than the one at which it was set during calibration without a load. Since camera 210 is secured to vehicle 200, it is possible to infer a displacement of the illumination area of headlights 240 by measuring a displacement of the pitch angle of camera 210. By evaluating the position of FOE 330 in image 300, it is possible to ascertain the static pitch angle and to compensate for it according to corresponding information provided to the control unit using a suitable control signal provided to an actuator system for displacing the illumination area.

Furthermore, it is to be made possible to determine the pitch angle of the vehicle in a very simple manner also using a range detector (i.e., a range sensor) on the rear axle. Then, for example, only one range detector on the rear axle is required to ascertain the inclination of the vehicle. In order to achieve this object in detecting the pitch angle, a range sensor may thus be present on the rear axle which records the downward spring deflection. The downward spring deflection for an empty vehicle is known. If the vehicle is then loaded, the downward spring deflection on the rear axle changes. It is possible to calculate how much weight has been loaded on the rear axle using the spring constant of the rear axle suspension. The overall payload is known using the mass estimation. The added front-axle load is then known using the difference between the overall payload and the payload on the rear axle. It is then possible to determine the downward spring deflection on the front axle using the spring constant on the front axle. The stationary pitch angle caused by the payload is thus also known through the evaluation of the downward spring deflection of the vehicle on the rear axle. Accordingly, it is also possible, for example, to carry out a plausibility check of the pitch angle which is determined based on a signal of the camera through the evaluation of the signal of the range sensor.

A further or additional option for determining (or carrying out a plausibility check on) the pitch angle may, for example, be determined using a function of the mass estimation already implemented in the vehicle, the vehicle weight being determined by this means precisely within a tolerance range of approximately 5%. In some vehicle safety systems, an internal vehicle mass estimation is used, for example, to adjust the stabilizing brake interventions to the instantaneous vehicle weight. This means that in a fully loaded vehicle, more powerful interventions are required for achieving stabilization than in a vehicle at empty load. In order also to be able to use this functionality of mass estimation for the headlight range adjustment, for example, the driving power developed by engine 280 is correlated with the actual available acceleration (for example, from a signal of acceleration sensor 290). The vehicle mass may also be inferred through the estimation of the characteristic speed (for example, from information provided by rotational speed sensor 250 at wheel 260). It is thus possible to calculate the payload with the aid of the known empty load.

This may be improved using a seat occupancy recognition system in order to achieve higher estimation accuracy. Sensors, which are not illustrated in FIG. 2, detect which vehicle seats are occupied and possibly the weight of these vehicle occupants. The engine rotational speed, wheel rotational speed, and/or other performance measured variables may then be used to calculate the load of the vehicle and/or the slope on which a vehicle is situated. The calculation of the traction of the wheels or the calculation of the wheel slip and/or the coefficient of friction may be used to ascertain the load of the wheel. By comparing the loads, it is possible to infer the load distribution of the vehicle and thus the prevailing pitch angle.

Under the approach described above, algorithms are used which are already implemented in the vehicle, which enable a calculation or estimation of the load of a vehicle and from which a control strategy for activating other safety functions is derived. Most new vehicles already have these safety functions. These algorithms may be used to estimate the load and to set the headlight range of the headlights accordingly. Through the use of the mass estimation of the vehicle and/or the evaluation of the camera image, it is possible, for example, to omit a separate level sensor system. Bright headlight systems thus become more economical and are able to penetrate the market more deeply.

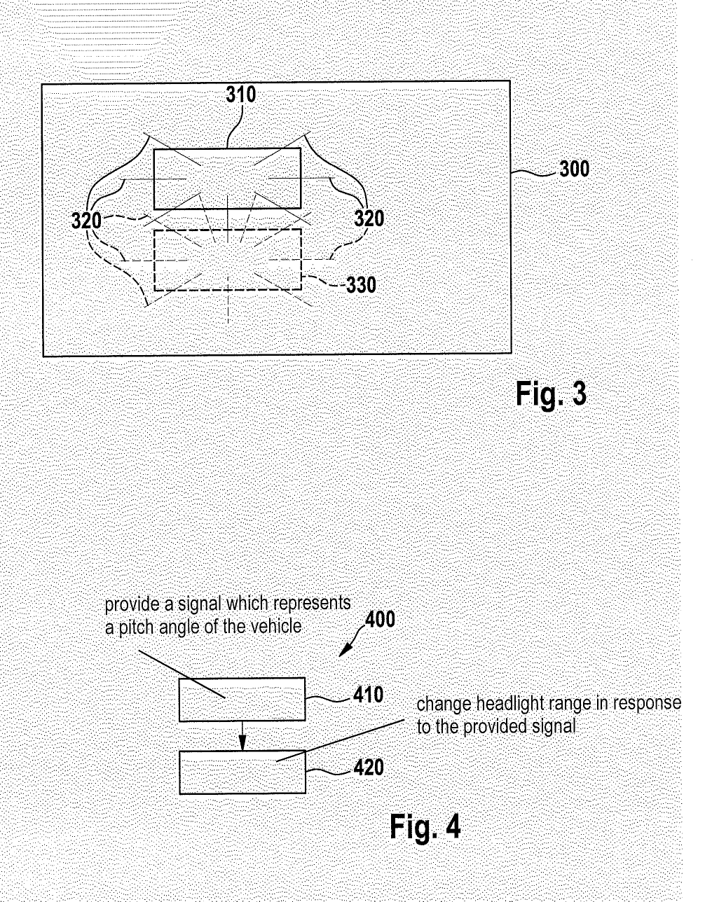

FIG. 4 shows a flow chart of an exemplary embodiment of the present invention as a method 400 for setting a headlight range of a headlight of a vehicle. Method 400 includes a step of provision 410 a signal which represents a pitch angle of the vehicle and a step of changing 420 the headlight range of the headlight in response to the provided signal.

The exemplary embodiments described and shown in the figures are selected only by way of example. Individual portions of the previously described exemplary embodiments may also be used alone in order to determine the signal which represents the pitch angle. Various exemplary embodiments may be combined completely or with respect to individual features, for example, to carry out plausibility checks on results from an alternative approach for ascertaining the signal which represents the pitch angle. An exemplary embodiment may also be supplemented through features of an additional exemplary embodiment.

Method steps according to the present invention may furthermore be repeated and executed in a sequence other than the one described.

If an exemplary embodiment includes an “and/or” link between a first feature and a second feature, this is to be read as meaning that the exemplary embodiment according to one specific embodiment has both the first feature and the second feature and has either only the first feature or only the second feature according to an additional specific embodiment.

1-11. (canceled)

12. A method for setting a headlight range of a headlight of a vehicle, comprising:
providing a signal which represents a pitch angle of the vehicle; and
changing the headlight range of the headlight in response to the provided signal.

13. The method as recited in claim 12, wherein in the providing step, the signal is provided using an image signal of a camera or an image signal of a sensor which detects the surroundings of the vehicle at least two-dimensionally.

14. The method as recited in claim 13, wherein the signal is provided using an image signal of the sensor and wherein the sensor is at least one of a forward-looking sensor and a backward-looking sensor.

15. The method as recited in claim 13, wherein in the providing step, the signal is provided using a result of an evaluation of the image signal from the camera or an image signal from the sensor detecting the surroundings, at least one of: i) a region of origin of the image signal from which objects seem to emerge being compared in a comparison with an expected region of origin from which objects should emerge at a known pitch angle of the vehicle in order to provide the signal based on a result of the comparison, and ii) a subsidence region of the image signal in which objects seem to disappear being compared in another comparison with an expected subsidence region in which objects should disappear at a known pitch angle of the vehicle in order to provide the signal based on the result of the other comparison.

16. The method as recited in claim 13, wherein in the providing step, an identification of a topographical profile of a road surface ahead of the vehicle is carried out, the providing of the signal taking into account the topographical contour.

17. The method as recited in claim 12, wherein in the providing step, the signal is provided based on an estimated or measured mass of the vehicle or a mass of a payload of the vehicle.

18. The method as recited in claim 17, wherein in the providing step, the signal is provided using a sensor signal of a range sensor on one axle of the vehicle.

19. The method as recited in claim 18, wherein in the providing step, the signal is provided based on the range sensor which is situated on a rear axle of the vehicle.

20. The method as recited in claim 12, wherein in the providing step, the signal is provided using at least one of information of an engine control unit, and driving data of the vehicle.

21. The method as recited in claim 12, wherein in the providing step, the signal is determined using information about at least one of a rotational speed of an engine of the vehicle, a rotational speed of at least one wheel of the vehicle, wheel slip, coefficient of friction of at least one wheel of the vehicle, an acceleration, and a drive torque of the engine of the vehicle.

22. A control unit for setting a headlight range of a headlight of a vehicle, the control unit comprising:
an interface to read in a signal which represents a pitch angle of the vehicle; and
a unit to change the headlight range of the headlight in response to the read-in signal.

23. A computer-readable storage medium storing a computer program having program code for setting a headlight range of a headlight of a vehicle, the program code, when executed by a control unit, causing the control unit to perform:
providing a signal which represents a pitch angle of the vehicle; and
changing the headlight range of the headlight in response to the provided signal.
